(19) United States
(12) Patent Application Publication
(10) Pub. No.: US 2012/0079946 A1
(43) Pub. Date: Apr. 5, 2012

(54) Self-cleaning vapor-condensing grease baffle filter

(76) Inventor: Jeffrey Bennett Dold, Sparks, NV (US)

(21) Appl. No.: 12/924,697

(22) Filed: Oct. 4, 2010

(51) Int. Cl. B01D 45/18; B01D 50/00

(52) U.S. Cl. 96/425; 55/283

(57) ABSTRACT

The subject of this patent application is an improved method for extracting grease and heat from the exhaust air over cooking equipment. This invention collects more grease than other grease baffle filters by combining principles of vapor condensation and centrifugal particulate separation. It converts waste heat into usable heat. It cools exhaust temperatures and reduces humidity on recirculating hood systems. It has self-cleaning capabilities using in-line heated water. It is programmable for automatic operation and performance monitoring. And it can be used with nearly any standard existing or new commercial kitchen exhaust hood as a replacement for the standard grease baffle filter.

### DESCRIPTION OF THE DRAWINGS

FIG. 1 is a representation of relation between the water paths and various parts of the system, cooking range and hood, and hot water heater.

FIG. 2 shows an exploded view of the actual filter to be installed in the existing exhaust hood.

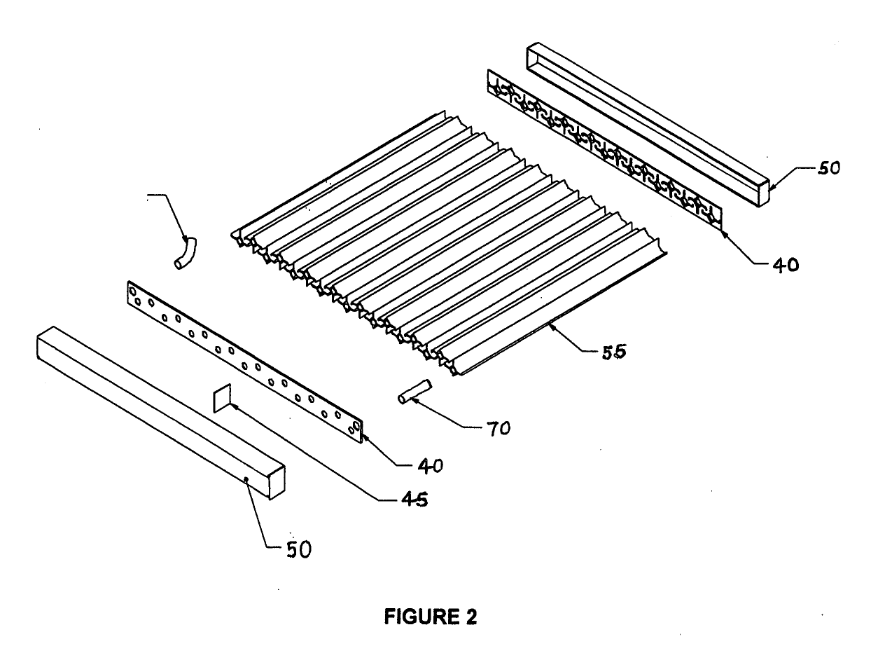

FIG. 3 shows front, side, and top views of the actual filter to be installed in the existing exhaust hood.

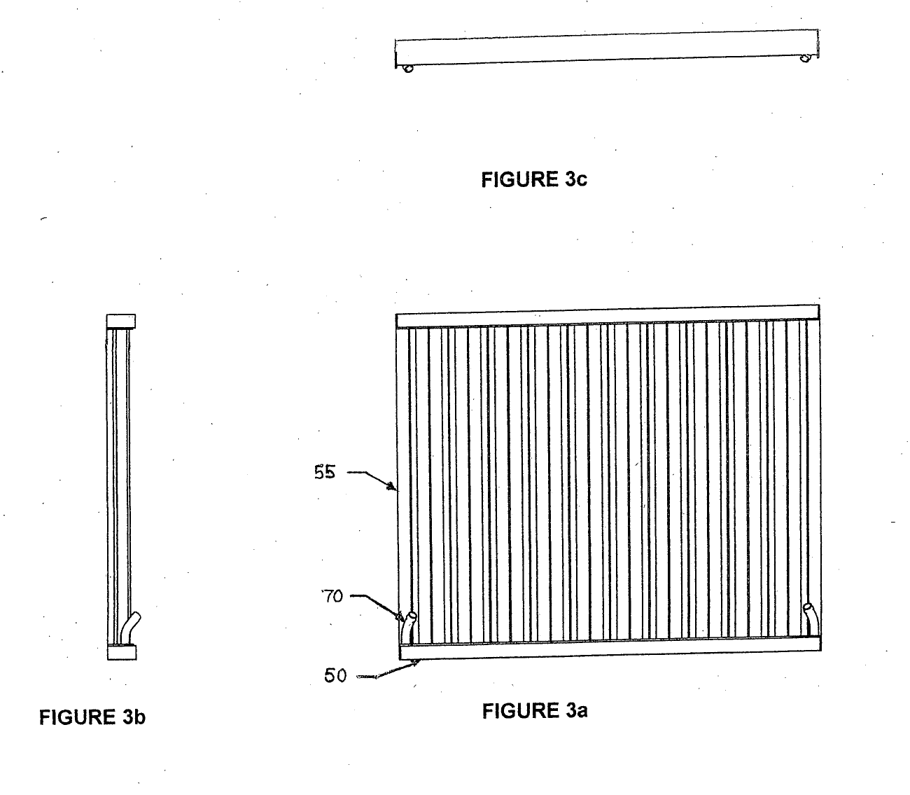

FIG. 4 shows an “end on” view of the finned conduits and diagrams the intended airflow through the filter.

FIG. 5 is a schematic of the path of the water through the system when the system is in “Cool Mode”.

FIG. 6 is a schematic of the path of the water through the system when the system is in “Clean Mode”.

FIG. 7 is a schematic of the path of the water through the system when the system is in “Bypass Mode”.

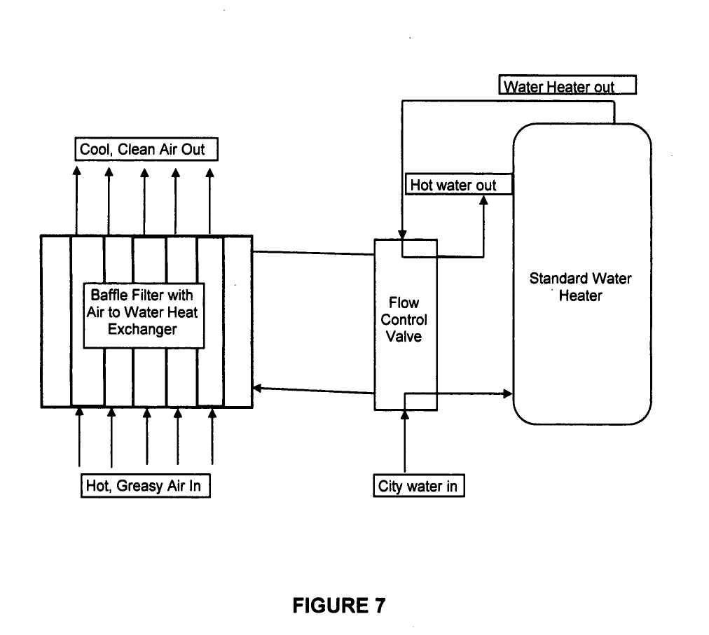

FIG. 8 is a schematic of the path of the water through the system with a heat exchanger.

### DETAILED DESCRIPTION

This invention may include: one or more filters (100), tubes to connect the filters in series, 3-way valves or one 6-way valve (30), valve Timer, performance monitoring system, pressure bypass valve (60) and plumbing fittings to connect the filters and valves between the cold water supply and the water heater.

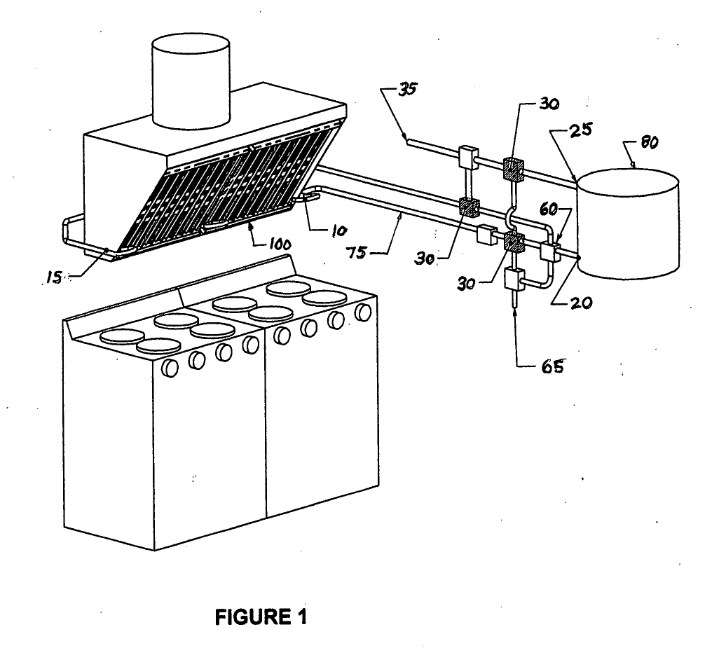

Plumbing connections should be made as shown in FIG. 1. The invention is placed in the exhaust hood, replacing an existing grease baffle filter (100).

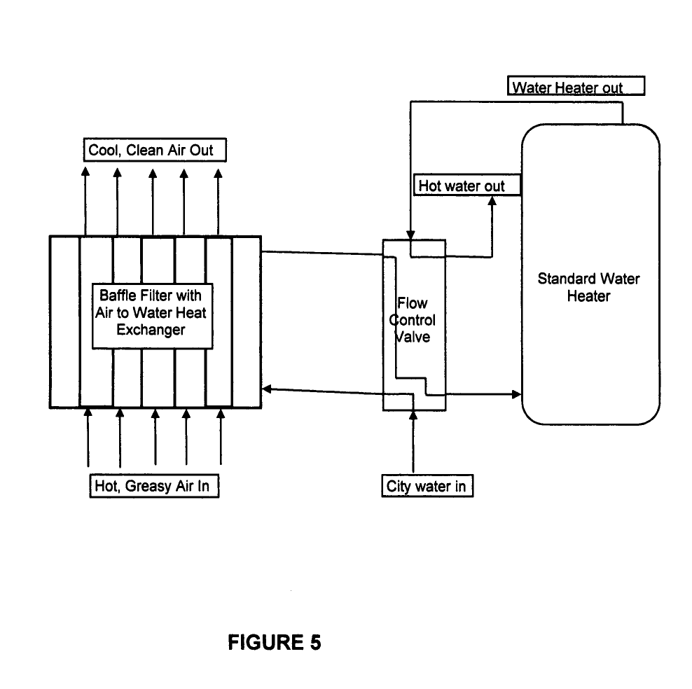

In “Cool Mode” most water will come from the cool water supply line (65) through a Control Valve (30). During high demand for hot water, some water might flow through the Pressure Bypass Valve (60) directly to the water heater to meet the high demand. Otherwise the water flows through the Connector Tubes (75), through the Connector (70) and through the first half of the Upper or Lower Manifold (50) where the Baffle (45) directs it through Manifold's Faceplate (40), into the Finned Conduits (55), through the opposite Manifold (50) and back down through the other Finned Conduits (55) to the second half of the Upper or Lower Manifold (50). The warm water then exits the filter through the second connector (70), through the Connector Tubes (75) and either into the neighboring filter or out to a Control Valve (30) and to the water heater inlet (20), as shown in FIG. 5.

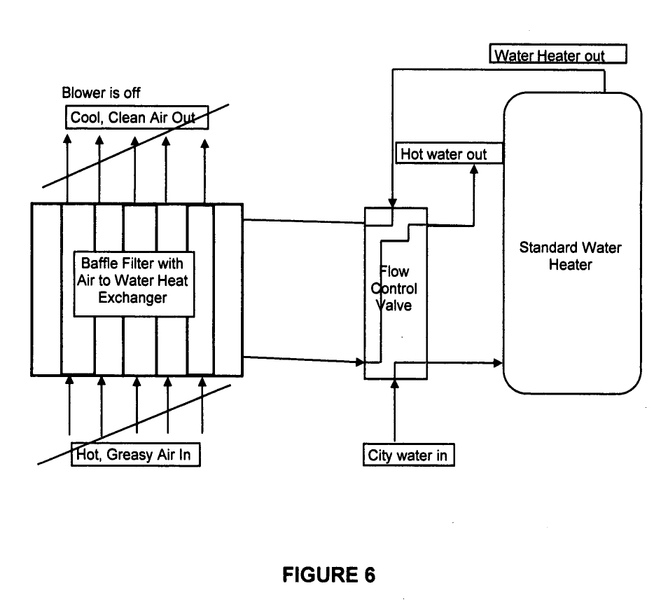

In the “Clean Mode” the cool water supply (65) is directed by the Control Valve (30) to the water heater (80), out to the Control Valve (30) and into the Upper or Lower Manifold (50). It is then directed up through the Finned Conduits (55) by the Baffle (45) and out through the other side of the filter (100) and through a Control Valve (30) to the hot water demand in the Kitchen (35), as shown in FIG. 6.

### Function

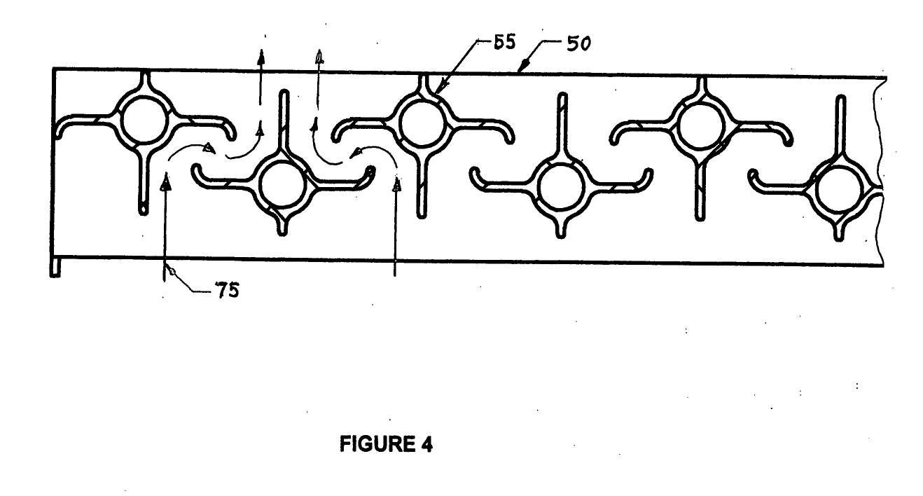

This invention functions in two modes. The first mode is for filtering and cooling the hot, grease- laden fumes produced by commercial cooking appliances during normal kitchen operation. The cooling process is accomplished by circulating cool water (from the city supply) (65) through the inside of the Finned Conduits (55) of the filter while the exhaust hood fan draws the hot air (75) through the outer surface of the Finned Conduits (55) of the filter as shown in FIG. 4. The heat transfers from the air to the Finned Conduits (55) then into the flowing water, thus substantially reducing the exhaust air temperature while increasing the temperature of the water. (This is most beneficial when used with recirculating hood systems that return exhaust air back to the kitchen after passing through the filtration system.) The water flows when a demand for hot water is created in the kitchen. The heated water then enters the kitchen water heater (80), thus reducing its required energy for operation. Refer to FIG. 4.

The filtering of the air is accomplished by a combination of centrifugal particulate separation (used by most common grease baffle filters) and vapor condensation (which is a new principle for this application). The unique shape of the Finned Conduits (55) cause the air to accelerate as it passes through the serpentine passage ways which causes air-born particulate matter to contact and adhere to the cold metal, separating it from the air.

The cold water flowing through the filter keeps the metal Finned Conduits (55) cool and causes the grease vapor and water vapor to condense out of the air and drip down the Finned Conduits into an existing Grease Tray below the filter, leaving the air dryer and cleaner than other filters would. This improved filtration system extends the life of the costly fabric pre-filters and HEPA filters, usually installed downstream of the baffle filters on recirculating systems. It also allows larger air passages in the filter, thus reducing the load on the exhaust fan, resulting in reduced power consumption. On hoods that exhaust to the outside environment, the improved vapor removal will reduce the need for frequent cleaning of the exhaust flue.

Since the process of condensation is exothermic, the phase change from vapor to liquid efficiently releases heat from the air into the water flowing through the filter, which causes the filter to act as a pre-heater for the main water heater.

The second mode of operation is for self-cleaning. This would normally occur every day after the kitchen is closed, the exhaust hood is turned off and the dishwasher is running. A single 6-way valve or a series of valves (30) as shown in FIG. 1 will enable water to flow from the outlet of the water heater (25) through the filter (100) and to a hot water demand in the kitchen (35), i.e. dishwasher. As the heated water passes through the filter (100) the heat transfers to the Finned Conduits (55) and into the grease causing it to melt and drip into the existing Grease Tray below, leaving the filter clean and ready for use the following day. The heated water is not dumped down the drain as it is when other filters are cleaned by hand, and the grease never coats the sink or clogs the drain or has to be separated from drain water. Instead, the grease collects automatically in the existing grease tray and remains separate for easy disposal. The water used for cleaning the grease from this invention flows through the internal water passages of the filter's Finned Conduits (55), and then goes to a hot water demand in the kitchen for its final use, thus drastically reducing energy and water consumption in the cleaning process.

The preferred embodiment employs a motorized 6-way valve and a Timer that can be programmed to operate automatically to cool during operating hours and to clean after hours, or to cycle at any frequency that the operator requires.

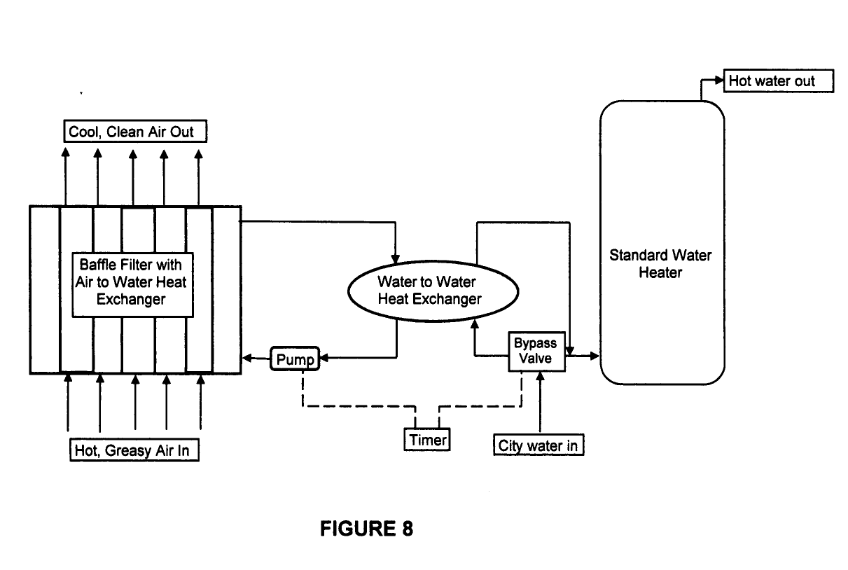

A second embodiment employs a water-to-water heat exchanger to permit closed-loop operation, isolating the fluid in the filter from the water supply to the kitchen (see FIG. 8).

Performance of the invention may be monitored and displayed by a data acquisition system. Differential temperature and flow rate will determine the amount of saved energy, which could be converted to an estimated cost savings and report it on a local monitor.

What is claimed is:

1. A self-cleaning grease filter utilizing the principles of condensation and centrifugal particulate separation composed of finned conduits, upper and lower manifolds, pressure bypass valve, automated actuating system, and a flow control valve.

2. Said self-cleaning grease filter of claim 1 will fit into most existing cooking hoods.

3. Said finned conduits of claim 1 are of such a design as to utilize the principle of centrifugal particulate separation to capture airborne grease and particulates.

4. Said finned conduits of claim 1 are designed such as to conduct fluid through their centers.

5. A multitude of said finned conduits of claim 1 are run in series between said upper and lower manifolds of claim 1.

6. Said upper and lower manifolds of claim 1 are composed of outlets, baffles, and fluid connectors.

7. Said outlets are adjoined to said finned conduits of claim 1 so as to permit fluid to flow from one manifold to the other manifold and vice versa via said finned conduits.

8. Said baffles are positioned in said manifolds so as to direct fluid through said finned conduits of claim 1.

9. Said fluid connectors are adjoined to fluid conductors so as to direct fluid to and from said flow control valve of claim 1.

10. Said flow control valve of claim 1 is configured to direct water flow as to be expressed in following claims.

11. When the system is in “Cool Mode”, said flow control valve of claim 1 will be in a position so water will be directed from the cool water supply to one of the said manifolds and through said finned conduits via said manifold so as to cool the surfaces of said finned conduits to aid in the capture of airborne grease and particulates. The water then flows through the other manifold and back to the flow control valve to be diverted to the building's existing water heater. While in “Cool Mode”, the flow control valve also directs flow from the water heater to a hot water demand.

12. When the system is in “Clean Mode”, said flow control valve of claim 1 will be in a position so water will be directed from the hot water heater to one of the said manifolds and through said finned conduits via said manifold so as to heat the surfaces of said finned conduits and thereby causing the grease and particulates captured by said finned conduits to run into the hood's grease collecting tray. The water then flows out the other manifold and to a hot water demand. While in “Clean Mode”, the flow control valve also directs flow from the cool water supply to the building's existing water heater.

13. Said pressure bypass valve of claim 1 will be configured so as to permit water to bypass the self-cleaning grease filter system and flow from the water heater to hot water demands should the demand exceed the capacity of the aforementioned “Clean Mode” cycle.

14. When the system is in “Bypass Mode”, said flow control valve of claim 1 will be in a position so water will be directed as it would flow in the absence of said system as follows: water from the cold water supply would be directed to the building's existing water heater, and water would be directed from the building's existing water heater to hot water demands, and all water passages going to and from said finned conduits and said upper and lower manifolds will be stopped via the flow control valve.

15. Said automated actuation system of claim 1 is of the kind being composed of a programmable timer and an actuation motor.

16. Said automated actuation system is connected to said flow control valve of claim 1 via said actuation motor.
